(19) United States
(12) Patent Application Publication
(10) Pub. No.: US 2006/0062427 A1
(43) Pub. Date: Mar. 23, 2006

(54) Method and arrangements for image recording for data detection and high-security checking of documents

(75) Inventors: Thomas Burkhart, Jena (DE); Juergen Hillmann, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Smiths Heimann Biometrics GmbH

(21) Appl. No.: 11/213,008

(22) Filed: Aug. 26, 2005

(30) Foreign Application Priority Data
Aug. 27, 2004 (DE) 10 2004 042 024.6

(51) Int. Cl. G06K 9/00

(52) U.S. Cl. 382/100

(57) ABSTRACT

The invention is directed to a method and an arrangement for image recording for data detection and security checking of documents, in particular for automated checking of the authenticity of documents in which hidden information for high-security checking is incorporated. It is the object of the invention to find a novel possibility for image recording for data detection and for checking the authenticity of documents which permits an automated detection of the presence of hidden information and high-resolution recording of hidden information for high-security checking in the shortest possible time and at the lowest cost in apparatus. This object is met according to the invention in that a total image of a document is recorded with relatively low image resolution in order to determine the document type, to associate stored security features with the document type, and in the event that the document type has a defined security feature whose evaluation requires a considerably higher image resolution, to switch the image recording unit to a limited higher-resolution image recording of a region of interest of the document, to record a high-resolution partial image, and to compare with the data of a database for checking authenticity.

### CROSS-REFERENCE TO RELATED APPLICATION

This application claims priority of German Application No. 10 2004 042 024.6, filed Aug. 27, 2004, the complete disclosure of which is hereby incorporated by reference.

### BACKGROUND OF THE INVENTION

a) Field of the Invention

The invention is directed to a method and arrangements for image recording for data detection and security checking of documents, wherein an image recording unit is oriented to a document for two-dimensional imaging of the document. The invention is preferably applied in combination document-reading and document-checking devices for automated checking of the authenticity of documents in which hidden information for high-security checking is incorporated.

b) Description of the Related Art

In addition to the visible image data and text data provided on the surface of identity documents, ID cards, visas, bank notes, and the like (hereinafter: documents), optical diffraction structures (e.g., kinegrams), watermarks, images or holograms are applied in particular; but hidden information is also applied by means of steganographic methods in order to prevent forgery of documents.

The hidden (or steganographic) information can only be read when the steganographic method is known. A typical example of application is the incorporation of hidden data in the identification picture of an identity document or travel document by means of analog or digital steganographic methods. In this case, usually names and/or document numbers are hidden in the picture in order to prevent a forgery through replacement of the picture. The basic problem in all of the methods employed consists in the optical detection of the image with sufficient quality and resolution to make it possible to evaluate the hidden information by means of a computer.

In the prior art, mainly analog steganographic data are made visible by placing a special plastic lens thereon and must then be evaluated manually. A procedure of this kind is known, for example, from EP 1 345 193 A2, where changes in the shape, size, angular position, density, or frequency of print elements in image elements or element groups (supercells) are carried out within a fixed supercell and are compensated in that the total brightness or color density of the supercell of the primary image and the primary image overlapped with the secondary image are identical, although individual print dots or image elements of the element group are changed in a predetermined manner.

In analog methods, depending on the method used for incorporating data, another plastic lens is used. Therefore, the respective lenses must be available (e.g., at a border control point) when checking identity documents with steganographic data for documents from different countries. The evaluation is time-consuming because it must be carried out manually.

The scanning process in digital methods generally requires a computer (e.g., a PC) with a flatbed scanner and special evaluating software at the control point. Further, an additional separate scanning process is required for each of the other checking processes (e.g., holograms, kinegrams, etc.) which substantially increases the time required for checking a document. Therefore, this high-security checking is too time-intensive for border controls and, at best, can be used when a document forgery is already suspected or for spot checks.

Document-reading and document-checking devices that are currently commercially available have so far not achieved the required resolution of at least 500 dpi or, due to the line-by-line scanning, simply require too much time for a standard check. Further, mechanical scanning devices are subject to wear which increases servicing and maintenance costs.

### OBJECT AND SUMMARY OF THE INVENTION

It is the primary object of the present invention to find a novel possibility for image recording for data detection and for checking the authenticity of documents which permits automated determination of the presence of hidden information and high-resolution recording of hidden information for high-security checking in the shortest possible time and at the lowest cost in apparatus. A further object consists in optically reading out text data, image data and/or hidden information in such a way that all other security features can be checked by the same checking device without the movement of mechanical parts or of the document being checked.

In a method for image recording for data detection and security checking of documents in which a document to be checked is imaged in two dimensions by means of an image recording unit, in particular for automated checking of the authenticity of documents in which hidden information is incorporated for security checking, the above-stated object is met, according to the invention, by the following sequence of steps:
a total image of the document is recorded with a relatively low image resolution, wherein the resolution is selected so as to be at least high enough that a document type can be determined from the recorded image,
the type of document is determined and stored security features are associated with the detected document type,
the detected document type is checked as to whether or not it has a defined security feature for which there must be a higher image resolution that is considerably higher than the image resolution with which the total image is recorded,
the image recording unit is switched to the higher image resolution and to a limited image recording in a region of interest of the document in case the document contains such a region with a defined security feature,
a high-resolution partial image of the region of interest is recorded and the recorded partial image is evaluated in case the security feature is present,
the authenticity of the document is checked by comparing the determined document data with data from a database or with data of the existing document (e.g., name or birth date of the document holder, etc.) which are to be expected at determined positions in accordance with the document type.

An image resolution of about 250 dpi is advantageously used for recording the total image of an identity document.

A partial image of the document with high-security features comprising hidden information is advisably read out at a higher image resolution as a region of interest. In identity documents, the identification picture is preferably read out as a partial image (region of interest containing hidden information).

When a region of interest with a high-security feature is read out as partial image of the document in an identity document, an image resolution of at least 500 dpi is advantageously used.

After determining the type of document based on the first total image, a sequence of different image recordings, preferably UV recordings, IR recordings, hologram recordings or diffraction recordings and high-resolution recordings for high-security features can advantageously be set.

The sequence of different image recordings is advisably set depending on the trustworthiness of the security features present in the document type. However, the sequence can also be determined depending on the evaluating time for the individual image recordings. If there is no hidden information present in a determined document type for a high-security check, a separate high-resolution partial image recording is not carried out.

Further, in an arrangement for image recording for data detection and security checking of documents in which an image recording unit is provided for two-dimensional imaging of a document to be checked, in particular for automated checking of the authenticity of documents in which specific security features are incorporated, the object of the invention is characterized in that the image recording unit has a two-dimensional image sensor and is directed to the document to be checked, wherein, in order to project a total image of the document on the image sensor in a format-filling manner and to read out the total image of the document with a relatively low resolution, the image sensor is arranged over the supporting surface, at least for a first image recording, in such a way that a camera control unit for switching the image recording unit from a total-image recording mode to a partial-image recording mode is connected to the image sensor in order to record a partial image of a limited region of interest on the document for the evaluation of specific security features with a higher image resolution in addition to the usual controlling of the image sensor readout, in that an evaluating unit having means for determining the document type from at least one total image of the document is arranged downstream of the image recording unit, wherein the camera control unit can be influenced, depending on the determined document type, for adjusting the image recording unit for the high-resolution image readout of a partial image of the region of interest on the document.

For switching between the recording of a total image and the recording of a partial image, the image sensor unit advantageously has a high-resolution recording objective and an image sensor with a very high pixel number and variable readout control, wherein the image sensor for recording the total image can be read out with a reduced resolution in that defined rows and columns are skipped and, for recording the partial image with higher resolution, only a pixel area of the image sensor on which the region of interest of the document is projected can be read out.

The evaluating unit is advisably provided with storage means from which the type and position of the specific security features can be retrieved after determining the type of document in order to program the pixel area of the image sensor to be read out.

In another advantageous variant for switching between total-image recording and partial-image recording, the image sensor unit has a high-resolution recording objective and an image sensor with a pixel number that is sufficient for recording the total image, variable readout control, and a microscan system, wherein the image sensor is displaceable in a scanning pattern for intermediate pixel scanning for recording the high-resolution partial image so that, in addition to the imaging position of the total image, displacements are carried out in fractions of the pixel distance in the row direction and column direction and only a pixel area of the image sensor on which the region of interest of the document is imaged is read out.

The image sensor is preferably arranged on a piezoelectric table system for carrying out the microscan. For most recordings of documents with high-security features, it is sufficient that the image sensor is movable in a 2×2 scan pattern.

The region of interest of a document advantageously has analog or digital high-security features with hidden information. As region of interest on an identity document, specific data of the document for preventing forgery are preferably integrated in the identification picture by steganography.

In a third constructional variant for switching between total-image recording and partial-image recording, the image sensor unit advantageously has a camera with a zoom objective and an image sensor with an average pixel number and is arranged so as to be displaceable parallel to the supporting surface of the document for switching from total-image recording to partial-image recording, wherein the camera is positioned centrally over the region of interest of the document for partial-image recording and, by zooming in with the recording objective, the region of interest in the document is imaged on the image sensor in a format-filling manner and consequently with a higher image resolution. The camera is preferably displaceable parallel to the supporting surface of the document by means of an x-y guide.

When switching to partial-image recording, the camera is advisably rotated additionally by 90° relative to the position for total-image recording in order to better adapt the rectangular shape of the image sensor to a portrait format or vertical format of an identification picture, as region of interest, relative to a landscape format or horizontal format of the total image of the document.

In a fourth embodiment form for switching between total-image recording and partial-image recording, the image sensor unit advantageously has a camera with a zoom objective and an image sensor with average pixel number, and a mirror arrangement comprising a deflecting mirror and a folding mirror is advisably provided for switching from total image to partial image, wherein the camera is positioned in a stationary manner over the document for recording the partial image and, by swiveling in the folding mirror and zooming in with the recording objective in the imaging beam path which is spatially offset by the folding mirror and deflecting mirror, the region of interest of the document is imaged on the image sensor in a format-filling manner and consequently with a higher image resolution.

In a fifth embodiment of the arrangement according to the invention for switching between total-image recording and partial-image recording, the image sensor unit advisably uses a camera with a zoom objective and with an image sensor of average pixel number and a mirror arrangement comprising deflecting mirror and semitransparent mirror for switching from total-image recording to partial-image recording, wherein the camera is positioned over the document in a stationary manner for recording the partial image and, by activating the deflecting mirror and zooming in with the recording objective in the imaging beam path which is spatially offset by the semitransparent mirror and deflecting mirror, the region of interest of the document is imaged on the image sensor in a format-filling manner and consequently with a higher image resolution.

In this case, for recording the partial image, the camera is again rotated additionally by 90° relative to the position for total-image recording in order to better adapt the rectangular shape of the image sensor to a vertical format of an identification picture, as region of interest, relative to a horizontal format of the total image of the document.

The deflecting mirror is advantageously coated with a layer that controls the reflectance, preferably with a liquid crystal layer. However, it may also be constructed as a tilting mirror in order to transmit the imaging beam path from the region of interest of the document to the semitransparent mirror only for partial-image recording and to fade out the imaging beam path for the total image of the document.

In a sixth variant of the invention, a first camera and a second camera, each with an image sensor of average pixel number and different recording objectives, are used as an image sensor unit for switching between total-image recording and partial-image recording, wherein the first camera is arranged rigidly and centrally over the document for recording the total image, and the second camera is arranged centrally over the region of interest of the document for recording the partial image, and the camera control has means for switching between the readout of the first camera and readout of the second camera.

The first camera and the second camera advisably have image sensors with the same pixel number. The second camera for recording the partial image is advisably arranged so as to be rotated by 90° relative to the position of the first camera for recording the total image in order to better adapt a rectangular shape of the image sensor to the vertical format of an identification picture as region of interest in the partial image and to the horizontal format of the document in the total image.

The basic idea of the invention proceeds from the realization that a resolution of at least 500 dpi is required for reading out steganographic information in the high-security method which, at a maximum surface of 130×90 mm to be detected for identity documents, results in the requirement of a minimum of 2560×1770 pixels of the image sensor. A resolution of only about 250 dpi is needed for reading out the visible data and image information of the document so that, compared to high-resolution imaging of steganographic information, only 25% of the amount of data needs to be detected and processed in an image sensor with 1280×885 pixels. For this reason, a general increase in resolution would not be sensible above all because of the increased expenditure of time for the more extensive data transfer and the longer evaluating period.

Therefore, according to the invention, an image of the document is first recorded within a combination document-reading and document-checking device with the low resolution which is sufficient for detecting the visible data and image information and, after identification of the document type with knowledge of the corresponding region that contains steganographic information, only this image section is detected with a high resolution (>500 dpi). Because the region is limited, the amount of data to be processed is not increased in spite of the high resolution and, therefore, there is no need for increased expenditure for the transfer and processing of data. Further, after the document type is identified, additional images of the entire document can be acquired for checking other security features (e.g., for IR image recordings and UV image recordings with suitably low resolution and/or with higher resolution with restricted region).

There are different variants suitable for realizing the basic method. On one hand, using a camera with a high-resolution image sensor (at least 2560×1770 pixels) and variably adjustable readout regime (skipping of columns and rows and selectable image sections), a total image of the document is recorded by skipping rows and/or columns during the readout process in order to make possible a reduction in data and a quick determination of the type of document by means of a lower resolution which, however, is sufficient for the detection of the document. With knowledge of the type of document, the limited region of the document with hidden information is then read out as a so-called WOI (Window of Interest) region with the highest resolution of the image sensor and the steganographic information is evaluated without the considerably greater amounts of data. A variant which is derived from this works with a lower-resolution image sensor which, however, by switching on a microscan system, achieves the higher resolution for the region of interest of the document and can be limited to the readout of the pixel region of interest of the image sensor.

On the other hand, commercially available cameras with lower pixel numbers (e.g., starting with 1.3 megapixels) can be used for more economical variants, wherein the optical imaging can be realized in different magnifications and in a spatially displaced manner for recording total images and partial images of the document with different resolutions. In one possible preferred variant, two suitably installed cameras (each with a minimum of 1.3 megapixels) are used instead of a mechanically moved camera, wherein one camera detects the entire document and the second camera records a magnified, high-resolution partial image of the document from the region containing steganographic information. Due to the absence of mechanically moving components, this variant has substantial advantages with respect to time and, in addition, is even less expensive than the arrangement with a high-resolution camera (about 5 megapixels).

By means of the invention, it is possible to detect hidden (steganographic) information of documents, wherein the presence of hidden information is determined automatically and recorded with high resolution for high-security checking in a very short time and at a low cost in apparatus. Further, advantageous developments make it possible to read out text data, image data, and/or hidden information optically without movement of mechanical parts or of the checked document such that all other security features can also be checked with the same checking device.

Further, the disadvantages of separate flatbed scanners (with additional time expenditure for high-resolution scanning of steganographic information) and the resulting long scanning times for acquiring the totality of data of a document (visible text data and image data, holograms, kinegrams and steganograms) are overcome in an economical manner with the solution according to the invention.

The invention will be described more fully in the following with reference to embodiment examples.

### BRIEF DESCRIPTION OF THE DRAWINGS

In the drawings:

FIG. 1 shows a flowchart for the method according to the invention for document checking for the detection and high-resolution recording of hidden (steganographic) information while simultaneously recording the rest of the text information and image information of the document;

FIG. 2 is a schematic view of an identity document as a total image, wherein a region of interest in the form of the identification picture is indicated;

FIG. 3 shows an arrangement according to the invention with a camera which has a high-resolution image sensor with variable readout control (WOI—Windows of Interest) and which enables data reduction in spite of the increased resolution of the image sensor;

FIG. 4 shows a variant equivalent to that shown in FIG. 3 in which the camera has an image sensor which has a lower resolution but which can carry out a microscan (2×2) for recording the partial image of the document and can limit the readout to a WOI region;

FIG. 5 shows an embodiment of the invention for recording a total image of the document and of a partial image of a steganographic region by means of a zoom camera which is displaceable parallel to the document supporting surface;

FIG. 6 shows an embodiment of the invention with a fixed zoom camera, a fixed mirror and a folding mirror for switching the visual field of the camera;

FIG. 7 shows an embodiment of the invention with a fixed zoom camera, a fixed mirror and a semitransparent mirror for switching the visual field of the camera;

FIG. 8 shows an embodiment of the invention with two suitably installed, equivalent cameras, one of which records the total image, while the other camera records an optically magnified steganographic region.

### DESCRIPTION OF THE PREFERRED EMBODIMENTS

It is assumed in the following—without limiting generality—that the document 1 to be checked is an identity document for which the hidden (steganographic) information is accommodated in the identification picture 11.

Since it is the express wish of border control authorities in particular that the detection of image data and text data and all security checking be accomplished as far as possible by placing a document 1 once on a document-reading and document-checking device, the image recording unit 2 must solve the conflict between frame readout time that is as short as possible and a high image resolution (>500 dpi) that is required at least for the evaluation of hidden information 12 in the document 1.

A resolution of at least 500 dpi is required for reading out steganographic data for high-security checking of documents 1. As a result, a minimum quantity of 2560×1770 image points (4.6 megapixels) is required for a maximum area of 130×90 mm to be detected for identity documents. However, a resolution of only about 250 dpi is needed to read out the (visible) image information and text information, so that for 1280×885 image points, which is sufficient for this purpose, only 25% of the data need be detected and processed compared to a high-resolution image for high-security checking.

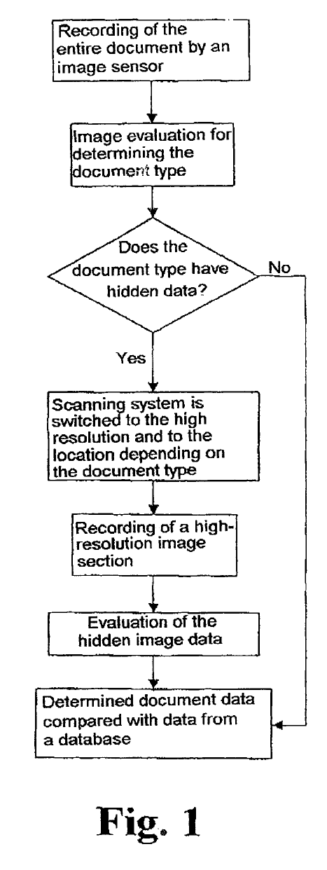

For this reason, the following method is applied according to the invention for the detection of hidden information in documents 1. The principle of this method is illustrated by a flowchart in FIG. 1.

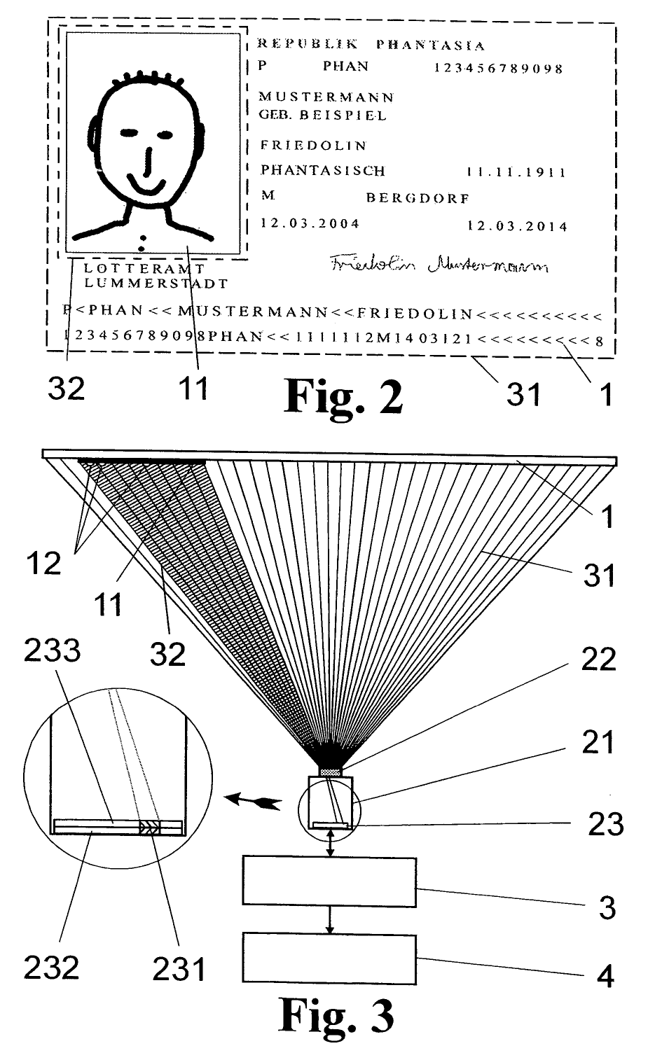

In a first step, a total image 31 (see FIG. 2) of the presented document 1 having only the necessary image point number (approximately 250 dpi) is recorded with a relatively low resolution in that the complete document 1 is optically imaged on the image sensor 23 of the camera 21 (only shown in FIG. 3 and the following figures) by means of a suitable objective 22 or 24.

In a second step, the type of document (e.g., German identity card, Indian entry visa, French EU passport, etc.) is determined from this total image 31 in the course of the evaluation and storage of the text data and image data. In this step, or as a sub-step, other security checks can be carried out, e.g., UV recordings and IR recordings of the document 1 and checking of holograms and kinegrams insofar as checking devices of this kind do not use lasers (e.g., as in DE 10 2004 020 661.9 which was not previously published).

The determined document type results in a storage inquiry (fetching of security features from a list of document types) to determine whether or not the (known) document type has steganographic information 12. If not, the check is terminated without a high-resolution partial-image recording and the document data that have already been read out are compared to the data from a database.

If the detected document type has hidden information 12, the position and the type of hidden information 12 can be taken from the stored lists of types of documents 1. With knowledge of the position, the imaging system 2 is switched in a fourth step to a high-resolution image recording of the region of interest which in the case of identity documents relates at least to the identification picture 11. Switching is a matter of executing a step from a large number of possibilities for recording the region of interest of the identification picture 11 with a substantially higher imaging density, i.e., with more pixels per area unit of the document 1. At least twice the resolution (>500 dpi) is required because this resolution is necessary in order to be able to detect coding steps in the print raster of the identification picture 11 such as those described, e.g., in the above-cited prior art EP 1 345 193 A2.

In a fifth step, which will not be discussed in more detail owing to the multitude of coding possibilities, an evaluation of the steganographic information 12 is carried out and, on this basis, it can be determined whether or not the hidden data fits together with the rest of the data read out from the document 1. In addition, another check of the authenticity of the document 1 can be carried out by comparing all of the data of the checked document 1 with data from an external database.

Since the time required for processing an individual is a critical variable in frontier traffic, it is ensured according to the invention that a passport reading and checking device that is supplemented by high-security checking records and processes only the images of a document 1 that are necessary for the specific document 1 to be checked.

In order to ensure this, the same recording control is always used, but can be supplemented optionally by additional checking steps with image readout provided these checking steps are meaningful or prescribed for the detected document type.

Accordingly, as is shown in the flowchart in FIG. 1, the heart of the invention is the recording and evaluation of a low-resolution image recording (approximately 250 dpi) from which the type of document 1 to be checked (e.g., a passport of whatever country) is determined in order to set all of the following readout steps and checking steps.

Based on this initial evaluation, the image recordings that are prescribed for checking security features of a document type, including or excluding a region with steganographic information 12, is first established. Based on the determined document type, the sequence of readout steps and checking steps is also set and executed or, as the case may be, terminated prematurely, possibly while taking into consideration (additional) intermediate results. Accordingly, according to the invention, passport-reading and checking devices in frontier traffic do not exceed the time frames to be adhered to for document control even when using a high-security checking method.

This basic method can be realized by means of different constructional variants.

In the device according to FIG. 3, a camera 21 which has a suitable high-resolution image sensor 23 (at least 2560×1770 pixels with variable readout control, WOI mode or overclocking mode) is used in combination with a suitable recording objective 22 (suitable normal objective or wide-angle objective). In the image sensors 23 that can be used, the characteristic of variable readout control is designated differently depending on the manufacturer. In CMOS technology, this application is called “Window of Interest” (WOI) or “Region of Interest” (ROI), “active window” and “windowing”. In CCD technology, the term “fast dump” is used to signify the skipping over of rows and “overclocking” is used to signify overclocking of unnecessary columns. The manner of operation is very similar in all cases, wherein there results a substantial data reduction (about one fourth to one sixteenth) and a considerable increase (at least twofold) in the image rate compared to the complete readout of the image sensor 23 (frame rate<20 images/second).

First, a total image 31 of the document 1 is recorded via the objective 22 of the camera 21 with the high-resolution image sensor 23 described above. A camera control unit 3 ensures that the document 1 is only read out with a resolution that is necessary for document identification (image detection and text detection), i.e., with the high-resolution image sensor 23 mentioned above, only every second, third or fourth row and/or column of the image sensor 23 is read out and transferred to the evaluating unit 4 for determining the document type depending on the required resolution. The rest of the rows and/or columns are skipped so that only a portion of the available pixels of the image sensor 23 makes up the total image 31 of the document 1, as is symbolized in FIG. 3 by the rastered side view of the image field of the camera 21, and is transferred to the evaluating unit 4 as a reduced image data set.

After the type of document is identified by means of the evaluating unit 4, additional images of the entire document 1 with a resolution that can be preselected as required can be detected (preferably prior to the steganographic evaluation) for checking additional security features, e.g., recording in infrared or ultraviolet light (not shown), possibly also with reduced resolution. A process control of this kind is again the responsibility of the camera control unit 3.

After all of the complete recordings of the document 1 have been made by reading out the high-resolution image sensor 23 with reduced resolution (by skipping columns and rows), then, in addition to the necessary determination of the document type, the simple (visible) security features of the document 1 are also checked so that high-resolution detection of a region of the document 1 in which steganographic information 12 is located (the type of document presently under consideration must have this) can be initiated when high-security checking is desired or prescribed.

The regions in document 1 which contain steganographic information 12 are known for every document type to be checked. For most identity documents and visas, this region is the identification picture 11 which is arranged near the upper left-hand corner of the document 1 in all documents 1 following the ICAO standard (see FIG. 2). With knowledge of the document type, this limited region (the identification picture 11 of the document 1 with hidden information 12) can be recorded and evaluated with the highest resolution without having to process considerably larger amounts of data.

FIG. 3 is an enlarged schematic detail of the image sensor 23 in a circle showing the control of the high-resolution partial-image recording 32.

Based on the determined document type, a readout region (WOI region) 231 is programmed into the register 232 of the image sensor 23 corresponding to the position of the region with steganographic information 12 (in this case, the position of the identification picture 11 of a document 1) in such a way that only the image section 233 of the identification picture 11 of the document 1 that is of interest is read out with the full resolution of the image sensor 23 and transferred to the evaluating unit 4.

This type of detection of the document 1 and restriction of the high-resolution image recording to the region of the identification picture 11 (with the steganographic information 12) ensures low transfer times (from the image sensor 23 to the evaluating unit 4) and low requirements for the evaluating unit 4 (due to reduced amounts of data). Moreover, the solution makes do without any moving parts and can be adapted to any type of document without spatial limitation of the position of the steganogram.

The current high price of surface sensors with sufficient pixel numbers (approximately 5 megapixels or more) and with variable adjustability of resolution and image sections (WOI—Windows of Interest) and the high requirements for the imaging optics (particularly for the modulation transfer function—MTF), which are therefore also expensive, still impose limits on the general use of this solution at border control points.

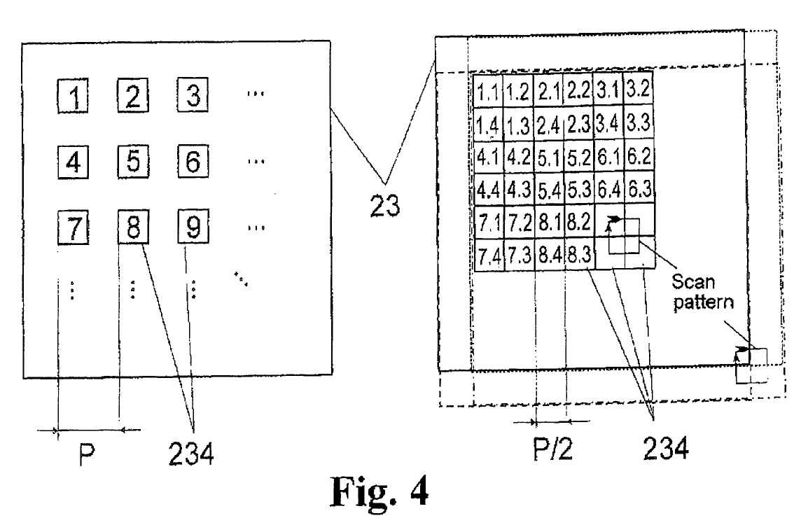

Therefore, a variant of the invention described with reference to FIG. 3 makes do with a more economical, lower-resolution image sensor 23 (250 dpi) instead of the high-resolution image sensor 23, but has a so-called microscan system which permits a subpixel scan of the image field when the recording of a partial image 32 is required for evaluating steganographic information. The principle of this sensor switching is shown schematically in FIG. 4, wherein the view at left shows the pixel positions (i.e., the raster of the light-sensitive elements) of the image sensor 23 that are active for the recording of the total image 31, while the scanning mode for the highly resolved recording of the partial image 32 is shown in the view at right. Accordingly, in the partial image mode, the entire image sensor 23 is moved, preferably by a piezoelectrically actuated table system (not shown), in a sequence of steps which permits the image of the presented document 1 to be scanned with the desired density in spite of the low pixel density of the image sensor 23.

As is shown by way of example in FIG. 4, a 2×2 scan is usually already sufficient for achieving the required resolution of the recording of steganographic information 12 (3×4 scans are likewise useful for higher resolutions and for pixel areas of the sensor that are frequently rectangular).

With the selected 2×2 scan, the image sensor 23 is moved back and forth in a rectangular scanning pattern in four steps from its original position twice along its row direction and its column direction by fractions of its pixel distance P (in this case by P/2), so that the pixels 234 assume positions n.1 to n.4, where n is the given pixel number. The results are shown on the right-hand side of FIG. 4 in the form of the dense pixel pattern (which is possibly also recorded in an overlapping manner) for the partial image 32 of the identification picture 11 of the document 1 (see FIG. 2).

Other variants of the solution based on the method according to the invention are described in the following examples. Two switchable image recordings (total image 31 and partial image 32) are realized and make do with less expensive image sensors 23 or commercially available camera types.

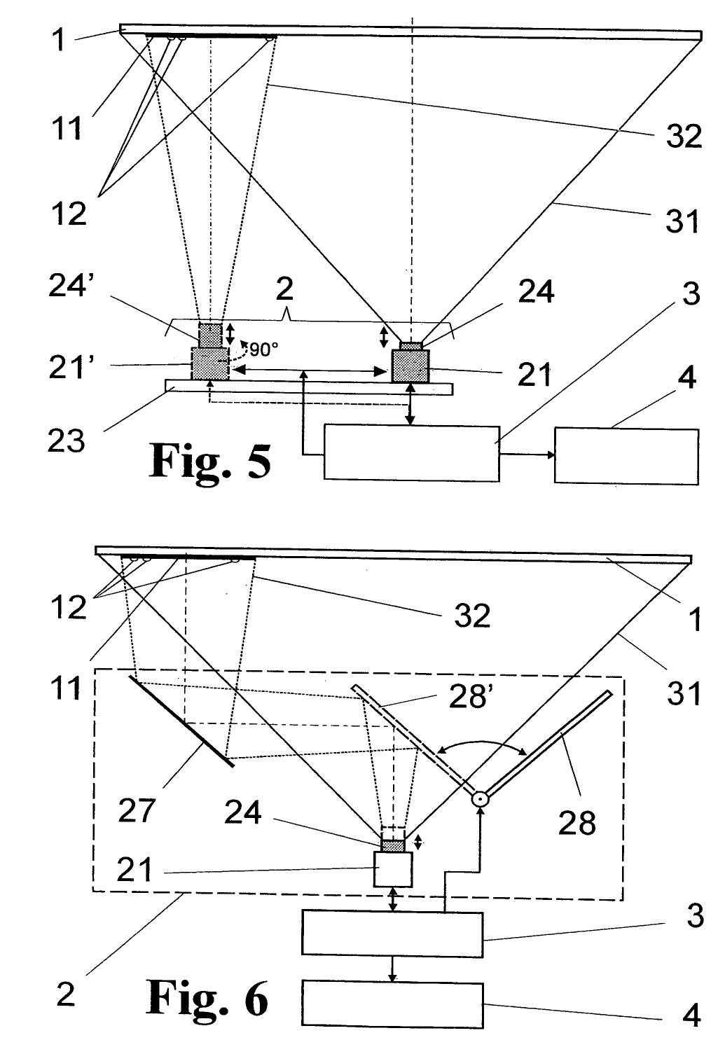

In this connection, FIG. 5 shows a device which uses a camera 21 with a zoom objective 24, wherein the camera 21 is arranged in an x-y guide 5 so as to be displaceable parallel to the support plane of the document 1. In order to record the entire document 1, the camera 21 is positioned centrally over the document 1 by means of the camera control unit 3 and the entire document 1 is imaged on the image sensor 23 (not shown in FIG. 5) by means of the motorized zoom objective 24. The total image 31 that is read out is transferred into the evaluating unit 4 to determine the document type. The position of the steganographic region (e.g., of the identification picture 11) that is determined in this way is conveyed to the camera control unit 3 to position the camera 21 for the recording of the steganographic information 12.

In order to detect the steganographic region within the identification picture 11, the camera 21 is positioned centrally over the latter. Preferably, in order to adapt the format of the identification picture 11 to the rectangular shape of the image sensor 23, the camera 21 is rotated by 90° relative to the position of the total image 31 and the zoom objective 24 is adjusted in such a way that the identification picture 11 fills up the entire surface of the image sensor 23. Under this condition, the increased resolution (>500 dpi) for the steganographic region can also be achieved by an inexpensive 1.3-megapixel CMOS sensor (e.g., LM9638, manufactured by National Semiconductor Corp., San Jose, USA).

The camera 21′ and the zoom objective 24′ are shown in dashes to illustrate the temporary displacement brought about when the camera 21 is brought into the position in which it is to record the partial image 32 of the identification picture 11 by means of the x-y guide 5. The zoom objective 24′ which is positioned in this way focuses the image of the identification picture 11. When the camera 21 with a resolution of 1280×1024 image points reaches the initial position for recording the total image 31, a resolution of only 1280 pixels/126 mm×25.4 mm/inch equals 258 dpi (sensor resolution/document width [in inches]).

When the camera 21 is rotated by 90° in the partial image position 21′ for detailed recording of the identification picture 11 (because the identification picture 11 is oriented in vertical format in contrast to the overall format of the document 1), a resolution of 1280 pixels/62.5 mm×25.4 mm/inches equals 520 dpi (sensor resolution/width of the identification picture [in inches]).

This calculation shows that the necessary resolution of >500 dpi for high-security steganograms in the partial image position 21′ of the camera 21 is achieved, although the image sensor 23 has only 1.3 megapixels. However, to make do without a 90-degree rotation, an image sensor 23 with 1850×1280 (2.4 megapixels) must be used.

FIG. 6 shows a variant of the image recording unit 2 that is modified from that shown in FIG. 5. Instead of displacing the camera 21, the imaging beam path of the camera 21 is deflected by a stationary mirror 27 and a folding mirror 28 from the total image 31 to a section of the document 1 and a partial image 32 of the identification picture 11 that is magnified multiple times is imaged on the image sensor 23 (shown only in FIG. 2) by means of the zoom objective 24. To record a total image 31 of the document 1, the folding mirror 28 is located outside the imaging beam path of the total image 31. The zoom objective 24 of the camera 21 images the entire document 1 on the image sensor 23 (not shown). The folding mirror 28 is then swiveled into the position, designated by 28′, in the beam path of the camera 21 and the zoom objective 24 zooms on the identification picture 11 by means of the stationary mirror 27. In order to achieve the maximum possible resolution of the image sensor 23 (with only 1.3 megapixels) that is preferably used, the camera 21 is rotated additionally by 90° as was already described with reference to FIG. 5.

Switching between the two image recording states is effected by the camera control unit 3 as in the preceding examples, wherein, preparatory to switching, the document type is again determined from the total image 31 of the document 1 and the swiveling of the folding mirror 28 and adjustment of the zoom objective 24 are controlled for the image recording of the identification picture 11 containing the steganographic information 12.

The calculation of the resolution within the total image 31 and partial image 32 corresponds to the variant with the x-y guide 5 of the camera 21 according to FIG. 5.

When the stationary mirror 27 is constructed so as to be larger than is shown in FIG. 6 or is likewise mounted so as to be easily swivelable, the region of interest—regardless of its location on the document 1—can be recorded with high resolution by varying the tilting angle of the mirror.

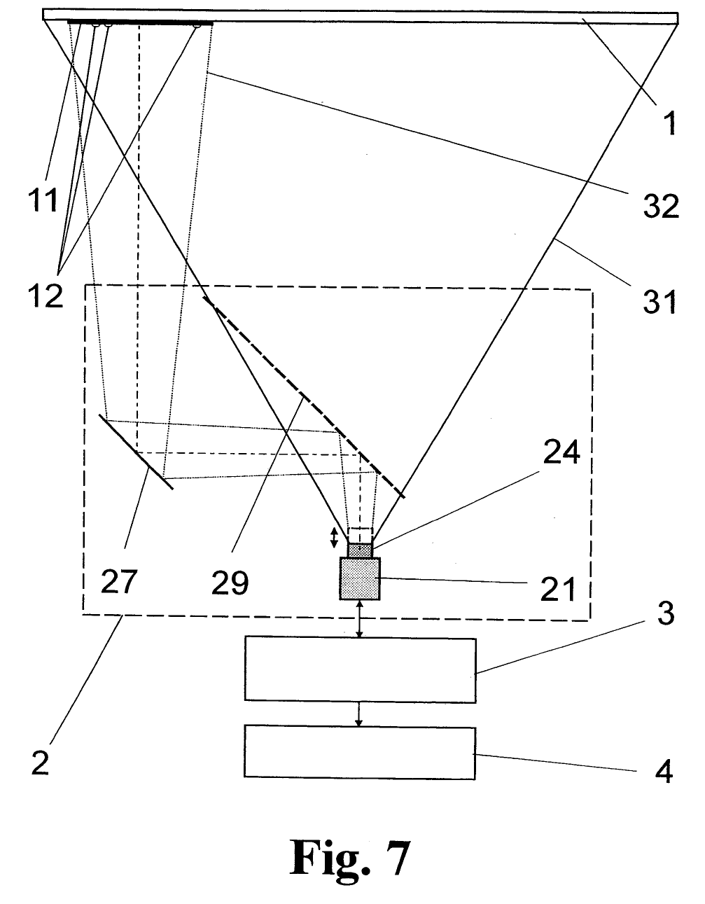

FIG. 7 shows another image recording unit 2 that is modified from that shown in FIG. 5 and in which, similar to FIG. 6, a mirror construction substitutes for the displacement of the camera 21. In this example, the change in position of the camera imaging is realized by means of a fixed mirror 27 and a semitransparent mirror 29. The beam path for the recording of the total image 31 penetrates the semitransparent mirror 29. The zoom objective 24 of the camera 21 images the entire document 1 on the image sensor 23 of the camera.

Assuming that the steganographic information 12 is located in the identification picture 11 of the document 1 and the image sensor 23 again has 1.3 megapixels, the camera 21 is rotated by 90° and the zoom objective 24 aims at the identification picture 11 in a smaller section of the document 1 in reflection via the semitransparent mirror 29 and the stationary mirror 27.

After recording and analyzing the total image 31, the visual field of the camera 21 is switched to the identification picture 11, as carrier of the steganographic information 12, based on the determined document type in that the camera control unit 3 controls the zoom objective 24 in a corresponding manner and activates the fixed mirror 27 whose reflectivity (e.g., through a liquid crystal layer) is attenuated when recording the total image 31. All of the rest of the processes take place in the same way as was described in FIGS. 3 to 6.

In the event that the steganographic information 12 is included in another region of the document 1 that need not be recorded in vertical format or in case a camera 21 with a 2.4-megapixel image sensor is available, the rotation of the camera 21 can be dispensed with. The resolution requirements are estimated analogous to the variant of the camera 21 with the x-y guide 5 (according to FIG. 5).

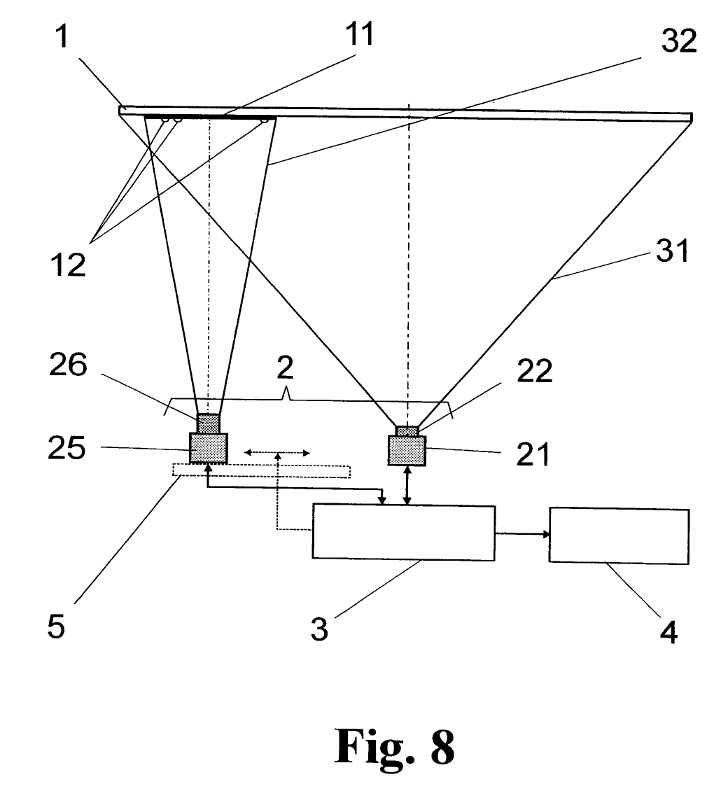

FIG. 8 shows yet another embodiment of the invention. Instead of the camera 21 (FIG. 5) which is arranged so as to be movable (relative to the partial image position 21′) and has 1.3 megapixels and a zoom objective 24, two fixedly adjusted cameras 21 and 25 (with the same pixel number) are used. The first camera 21 acquires the entire document 1 via a wide-angle recording objective 22 and the second camera 25 acquires the region of the identification picture 11 by means of its objective 26. The cameras 21 and 25 do not need zoom objectives as in the preceding embodiment examples according to FIGS. 5 to 7; rather, each camera preferably has an objective 22 and 26, respectively, with a fixed focal length and diaphragm. The first camera 21 images the entire document 1, while the second camera 25, whose image plane—in case it should record the vertical-format region of the identification picture 11—is rotated by 90° relative to that of the first camera 21, acquires the magnified partial image 32 of the region with steganographic information 12.

To record the entire document 1, the camera control unit 3 activates the camera 21 and provides for a recording of the total image 31. The second camera 25 is then activated and makes a recording of the identification picture 11. The calculation of the resolution is identical to that described in the example given in FIG. 3.

In the design variant in FIG. 8, no motorized zoom objective 24 is needed and no time is wasted on zooming or focusing the objectives 24 and 26 or changing the position of a camera 21. Accordingly, no mechanically moving parts need to be used, provided it is not necessary to adjust different positions of the steganographic regions of the document 1 for different document types.

Due to the fact that a 5-megapixel sensor is ten times more expensive than a 1.3-megapixel sensor, the use of two equivalent commercially available cameras 21 and 25 (with 1.3 megapixels) is also an attractive solution from a cost perspective.

All four of the solutions mentioned above (referring to FIGS. 5, 6, 7 and 8) are characterized in that they are also capable of reading out high-security features of documents 1 (e.g., steganograms in identification pictures 11 of identity documents) with a high resolution using an inexpensive CMOS sensor and supplying them to an evaluating unit 4 having corresponding database access and suitable evaluating software. A total image 31 of the document 1 is acquired in an optimal low resolution so that the amount of data is reduced and the resource requirements for the evaluating unit 4 are kept low.

Through intelligent recording control by means of the camera control unit 3, it is ensured that the additional high-resolution recording of a region with high-security features is carried out only in documents 1 which have steganographic information 12 (e.g., in the identification picture 11). Therefore, the processing time for a document 1 not containing steganographic information 12 is not increased unnecessarily and is effectively incorporated within the rest of the optical readout and test procedures in documents that contain hidden information 12.

Regardless of which of the above-mentioned variants for document image recording different image resolution are used, it is always necessary to provide an intelligent recording control which decides, based on the actual document type to be processed, whether or not, when, where and how an additional high-resolution partial image 32 is required.

While the foregoing description and drawings represent the presentinvention, it will be obvious to those skilled in the art that various changes may be made therein without departing from the true spirit and scope of the present invention.

Reference Numbers

1 document

11 identification picture

12 hidden (steganographic) information

2 image recording unit

21 camera

22 recording objective (fixed)

23 image sensor

231 readout region (WOI region)

232 register

233 image section of interest

234 pixels (light-sensitive elements of the image sensor)

24 zoom objective

25 second camera

26 objective

27 (fixed) mirror

28 folding mirror

29 semitransparent mirror

3 camera control unit

31 total image

32 partial image (section of the document)

4 evaluating unit

5 x-y guide

P pixel distance

What is claimed is:

1. A method for image recording for data detection and security checking of documents in which a document to be checked is scanned in two dimensions by means of an image recording unit, in particular for automated checking of the authenticity of documents, comprising the following steps:
recording a total image of the document with a relatively low image resolution, wherein the resolution is selected so as to be at least high enough that a document type can be determined from the recorded image;
determining the type of document and associating stored security features with the detected document type;
checking the detected document type as to whether or not it has a defined security feature whose optical detection requires a higher image resolution that is considerably higher than the image resolution with which the total image is recorded;
switching the image recording unit to the higher image resolution and to a limited image recording in a region of interest of the document in the event that the document contains such a region with a defined security feature;
recording a high-resolution partial image of the region of interest and evaluating the recorded partial image in the event that the security feature is present; and
checking the authenticity of the document by comparing the document data determined from at least one image recording for a security feature with data from the recorded total document and/or with data from a database.

2. The method according to claim 1, wherein an image resolution of about 250 dpi is used for recording the total image of an identity document.

3. The method according to claim 1, wherein a partial image of the document with high-security features comprising hidden information is read out at a higher image resolution as a region of interest.

4. The method according to claim 3, wherein a partial image with the identification picture is read out as region of interest of an identity document containing hidden information.

5. The method according to claim 3, wherein an image resolution of at least 500 dpi is used for recording the region of interest with a high-security feature in an identity document.

6. The method according to claim 1, wherein a sequence of different image recordings, such as UV recordings, IR recordings, hologram recordings or diffraction recordings and high-resolution recordings for high-security features, is set after determining the type of document based on the first total image.

7. The method according to claim 6, wherein the sequence of different image recordings is set depending on the trustworthiness of the security features present in the document type.

8. The method according to claim 6, wherein the sequence is set depending on the evaluating time.

9. An arrangement for image recording for data detection and security checking of documents comprising:
an image recording unit being provided for two-dimensional imaging of a document to be checked, in particular for automated checking of the authenticity of documents in which specific security features are incorporated;
said image recording unit having a two-dimensional image sensor;
said image sensor being arranged over the supporting surface, at least for a first image recording, in order to project a total image of the document on the image sensor in a format-filling manner and to read out the total image of the document with a relatively low resolution;
a camera control unit for switching the image recording unit from a total-image recording mode to a partial-image recording mode being connected to the image sensor in order to record a partial image of a limited region of interest on the document for the evaluation of specific security features with a higher image resolution in addition to the usual controlling of the image sensor readout; and
an evaluating unit having means for determining the document type from at least one total image of the document being arranged downstream of the image recording unit, wherein the camera control unit can be influenced, depending on the determined document type, for adjusting the image recording unit for the high-resolution image readout of a partial image of the region of interest on the document.

10. The arrangement according to claim 9, wherein, for switching between the recording of a total image and the recording of a partial image, the image sensor unit has a high-resolution recording objective and an image sensor with a very high pixel number and variable readout control, wherein the image sensor for recording the total image can be read out with a reduced resolution by skipping defined rows and columns and, for recording the partial image with higher resolution, only a pixel area of the image sensor on which the region of interest of the document is projected can be read out.

11. The arrangement according to claim 10, wherein the evaluating unit is provided with storage means from which the type and position of the specific security features can be retrieved after determining the type of document in order to program the pixel area of the image sensor to be read out.

12. The arrangement according to claim 9, wherein, for switching between total-image recording and partial-image recording, the image sensor unit has a high-resolution recording objective and an image sensor with a pixel number that is sufficient for recording the total image, variable readout control, and a microscan system, wherein the image sensor is displaceable in a scanning pattern for intermediate pixel scanning for recording the high-resolution partial image so that, in addition to the imaging position of the total image, displacements are carried out in fractions of the pixel distance in the row direction and column direction and only a pixel area of the image sensor on which the region of interest of the document is imaged is read out.

13. The arrangement according to claim 12, wherein the image sensor is arranged on a piezoelectric table system.

14. The arrangement according to claim 12, wherein the image sensor is movable in a 2×2 scan pattern.

15. The arrangement according to claim 9, wherein the region of interest of a document has high-security features with hidden information.

16. The arrangement according to claim 15, wherein the region of interest is an identification picture on the document in which specific data of the document for preventing forgery are integrated in the identification picture by steganography.

17. The arrangement according to claim 9, wherein, for switching between total-image recording and partial-image recording, the image sensor unit has a camera with a zoom objective and an image sensor with an average pixel number and is arranged so as to be displaceable parallel to the supporting surface of the document for switching from total- image recording to partial-image recording, wherein the camera is positioned centrally over the region of interest of the document for partial-image recording and, by zooming in with the recording objective, the region of interest in the document is imaged on the image sensor in a format-filling manner and consequently with a higher image resolution.

18. The arrangement according to claim 17, wherein the camera is displaceable parallel to the supporting surface of the document by means of an x-y guide.

19. The arrangement according to claim 18, wherein, when switching to partial- image recording, the camera is rotated additionally by 90° relative to the position for total-image recording in order to better adapt the rectangular shape of the image sensor to a vertical format of an identification picture, as region of interest, relative to a horizontal format of the total image of the document.

20. The arrangement according to claim 9, wherein, for switching between total-image recording and partial-image recording, the image sensor unit has a camera with a zoom objective and an image sensor with average pixel number, and a mirror arrangement comprising a deflecting mirror and a folding mirror is provided for switching from total-image recording to partial-image recording, wherein the camera is positioned in a stationary manner over the document for recording the partial image and, by swiveling in the folding mirror and zooming in with the recording objective in the imaging beam path which is spatially offset by the folding mirror and deflecting mirror, the region of interest of the document is imaged on the image sensor in a format-filling manner and consequently with a higher image resolution.

21. The arrangement according to claim 9, wherein, for switching between total- image recording and partial-image recording, the image sensor unit has a camera with a zoom objective and with an image sensor of average pixel number and a mirror arrangement comprising deflecting mirror and semitransparent mirror is provided for switching from total- image recording to partial-image recording, wherein the camera is positioned over the document in a stationary manner for recording the partial image and, by activating the deflecting mirror and zooming in with the recording objective in the imaging beam path which is spatially offset by the semitransparent mirror and deflecting mirror, the region of interest of the document is imaged on the image sensor in a format-filling manner and consequently with a higher image resolution.

22. The arrangement according to claim 21, wherein the camera is rotated additionally by 90° relative to the position for total-image recording for recording the partial image in order to better adapt the rectangular shape of the image sensor to a vertical format of an identification picture, as region of interest, relative to a horizontal format of the total image of the document.

23. The arrangement according to claim 21, wherein the deflecting mirror is coated with a layer that controls the reflectance.

24. The arrangement according to claim 23, wherein the deflecting mirror is coated with a liquid crystal layer.

25. The arrangement according to claim 21, wherein the deflecting mirror is constructed as a tilting mirror in order to transmit the imaging beam path from the region of interest of the document to the semitransparent mirror only for partial-image recording.

26. The arrangement according to claim 9, wherein the image sensor unit has a first camera and a second camera, each with an image sensor of average pixel number and different recording objectives, for switching between total-image recording and partial-image recording, wherein the first camera is arranged rigidly and centrally over the document for recording the total image, the second camera is arranged centrally over the region of interest of the document for recording the partial image, and the camera control has means for switching between the readout of the first camera and the readout of the second camera.

27. The arrangement according to claim 26, wherein the first camera and the second camera have equivalent image sensors.

28. The arrangement according to claim 27, wherein the second camera for recording the partial image is arranged so as to be rotated by 90° relative to the position of the first camera for recording the total image in order to better adapt a rectangular shape of the image sensor to the vertical format of an identification picture as region of interest in the partial image and to a horizontal format of the document in the total image.
